(19) United States
(12) Patent Application Publication
(10) Pub. No.: US 2017/0248262 A1
(43) Pub. Date: Aug. 31, 2017

(54) CONNECTION MECHANISM BETWEEN VALVE AND JOINT IN AIR PIPING

(71) Applicant: NITTA CORPORATION, Osaka (JP)

(72) Inventor: Yasuaki TANIGUCHI, Nabari-shi (JP)

(73) Assignee: NITTA CORPORATION, Osaka (JP)

(21) Appl. No.: 15/521,738

(22) PCT Filed: Sep. 14, 2015
(86) PCT No.: PCT/JP2015/076032

§ 371 Date: Apr. 25, 2017

(30) Foreign Application Priority Data
Oct. 31, 2014 (JP) 2014-222396

(51) Int. Cl. F16L 37/14; F16K 27/00; F16L 27/093

(52) U.S. Cl. CPC F16L 37/144; F16L 27/093; F16L 37/146; F16K 27/00

(57) ABSTRACT

Provided is a connection mechanism for connecting a tube through a joint to a housing of a valve. At least one of the housing of the valve and the joint is made of a resin. The housing of the valve includes a connection hole for inserting and connecting the joint, and pin insertion holes which is drilled from an external surface of the housing in a direction orthogonal to an axial direction of the connection hole, and penetrates through the connection hole. An annular groove is formed along a circumferential direction of an outer peripheral surface of the joint. In an insertion state of the joint into the housing, the pin is inserted from the pin insertion holes on the external surface of the housing. The pin passes through the annular groove disposed on the joint and comes into engagement with the joint.

### TECHNICAL FIELD

The present invention relates to a connection mechanism between a valve and a joint in air piping, for example, air brake piping for a vehicle, such as a truck.

### BACKGROUND ART

In general, a large truck is uses air in order to control and drive a brake and accessories. Therefore, a number of air valves, air tanks, and air actuators are used. Conventionally, in a joint that connects a tube to a valve, a tapered screw joint is fastened to the valve. Taking strength and durability into consideration, the valve and the joint are therefore manufactured using a metal, such as iron, brass, stainless steel, and aluminum (Patent document 1).

FIG. 7 shows a conventional connection mechanism between a valve and a joint. A housing 20 of a metal valve is provided with a screw hole 220 having a tapered screw on an inner peripheral surface thereof. The connection is made by screwing a male screw part 120 disposed on a metal joint 10 into the screw hole 220.

Meanwhile, there is a desire to manufacture the valve and the joint by using a resin instead of a metal for the purpose of lightweighting and cost saving. However, the resin has lower creep properties than the metal, and it is therefore difficult to retain airtightness over a long term.

Although it has been known to make connection using a gasket or O-ring by applying a parallel screw, such a metric screw and a general purpose screw, to a connection part, there is a likelihood that a resin screw could become loose due to vibration or the like during use. When the joint has an L-type elbow shape, it is necessary to have a mechanism for permitting rotation of a joint body part and a screw part (a swivel structure) in order to direct the joint in any direction. This leads to a complicated and expensive structure.

Although there are some cases where a resin material is used for a joint part intended for general industry, polybutylene terephthalate (PBT) is used for the resin material. It is therefore difficult to apply the resin material to an air piping valve for use in a vehicle, such as a truck, in view of rigidity, heat resistance, and chemical resistance.

### PRIOR ART

### Patent Document

Patent Document 1: Japanese Unexamined Patent

### SUMMARY OF THE INVENTION

Problems to be Solved by the Invention

A major object of the present invention is to provide a connection mechanism between a valve and a joint, which is free from problems related to airtightness and loosening.

Another object of the present invention is to provide a connection mechanism between a valve and a joint, which is capable of rotating the joint in any direction without employing the swivel structure even when the joint has an elbow shape.

### Means for Solving the Problems

A connection mechanism between a valve and a joint according to the present invention is the mechanism configured to connect a tube through the joint to a housing of the valve in air piping. At least one of the housing of the valve and the joint is made of a resin. The housing of the valve includes a connection hole configured to accept insertion and connection of the joint, and an engaging member insertion hole which is drilled from an external surface of the housing in a direction orthogonal to an axial direction of the connection hole, and penetrates through the connection hole. The joint includes an annular groove formed along a circumferential direction of an outer peripheral surface of the joint. In an insertion state of the joint into the housing, an engaging member being inserted from the engaging member insertion hole on the external surface of the housing is configured to pass through the annular groove formed on the joint and come into engagement with the joint.

Another connection mechanism of the present invention is the mechanism configured to connect a tube through a joint to a housing of a valve in air piping.

At least one of the housing of the valve and the joint is made of a resin. The housing of the valve includes a connection hole configured to accept insertion and connection of the joint. In an insertion state of the joint into the housing, a plate member for preventing disengagement of the joint is configured to be attached to a front surface of the housing and engaged with the joint.

### Effect of the Invention

According to the present invention, the connection between the valve and the joint is not made by a screwing structure as in a conventional manner, but made by the structure that the engaging member, such as a pin, being inserted from the external surface of the housing of the valve extends through the annular groove formed on the joint and comes into engagement with the joint.

Therefore, even when the resin is used for the housing of the valve and the joint, there is no likelihood of loosening due to vibration or the like, and airtightness is retainable. The present invention, employing the above connection mechanism, makes it possible to use the resin instead of a metal for one or both of the housing of the valve and the joint, thus leading to lightweighting and cost saving.

A similar effect to that described above is attainable even when employing the structure that the plate member for preventing disengagement of the joint is attached to the front surface of the housing so as to be engaged with the joint, instead of the engaging member, such as the pin, configured to be inserted from the external surface of the housing.

Additionally, with the above connection mechanisms of the present invention, it is possible to rotate the piping in any direction even for an elbow-shaped joint without employing the swivel structure.

### BRIEF DESCRIPTION OF THE DRAWINGS

FIG. 1 is a perspective view that shows a connection mechanism according to a first embodiment of the present invention;

FIG. 2 is a partially cut-away explanatory drawing that shows a state before connection in the first embodiment of the present invention;

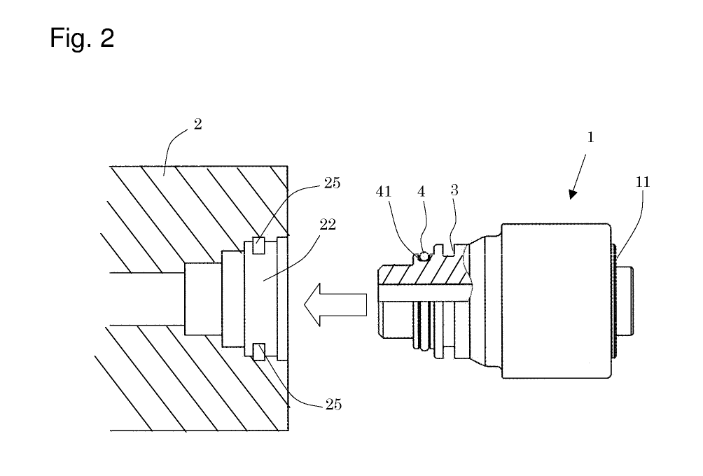

FIG. 3 is a partially cut-away explanatory drawing that shows a state after connection in the first embodiment of the present invention;

FIG. 4 is a side view that shows an example of an elbow-shaped joint;

FIG. 5 is an explanatory drawing that shows a connection mechanism according to a second embodiment of the present invention;

FIG. 6 is an explanatory drawing that shows an engagement state of a plate member in the second embodiment; and

FIG. 7 is an explanatory drawing that shows a conventional connection mechanism between a valve and a joint.

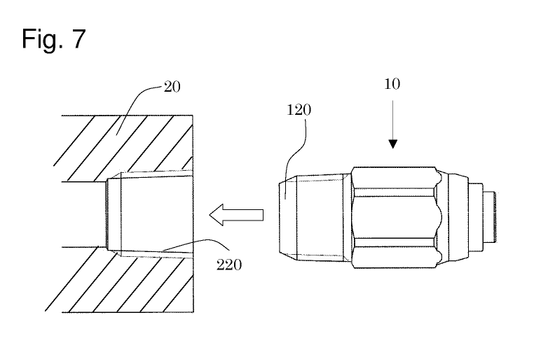

### PREFERRED EMBODIMENTS FOR CARRYING OUT THE INVENTION

A piping joint of the present invention is described below with reference to the drawings.

### First Embodiment

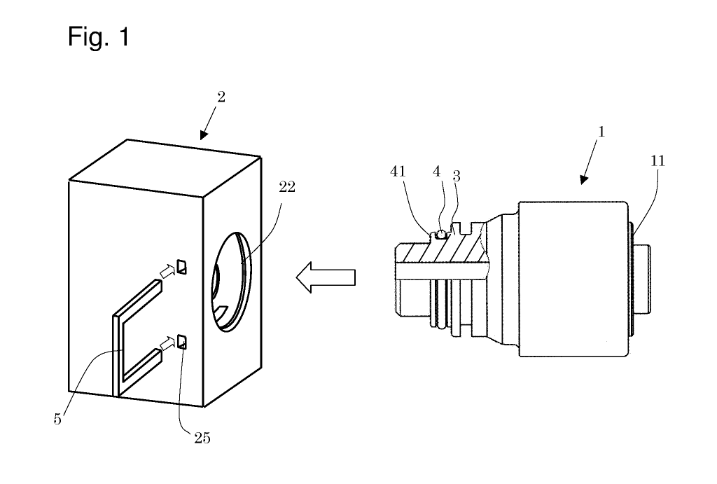

As shown in FIG. 1, a connection mechanism according to a first embodiment of the present invention is the mechanism that connects a joint 1 and a housing 2 of a valve. At least one of the joint 1 and the housing 2 of the valve is made of a resin. As a usable resin, there are, for example, resins having high heat resistance, such as polyphthalamide (PPA), polyhexamethylene terephthalamide (PA6T), polynonamethylene terephthalamide (PA9T), polydecamethylene terephthalamide (PA10T), polyundecamethylene terephthalamide (PA11T), poly(meta-xylyleneadipamide) (PAMXD6), polyphenylene sulfide (PPS), syndiotactic polystyrene (SPS), polycaproamide (PA6), polyhexamethylene adipamide (PA66), polyundecanamide (PA 11), and polydodecanamide (PA12). Examples of usable metals include aluminum, iron, and copper.

The housing 2 of the valve is provided with a connection hole 22 configured to accept insertion and connection of the joint 1, and air is fed through the connection hole 22. Two pin insertion holes 25 (engaging member insertion holes) are drilled in a direction orthogonal to an axial direction of the connection hole 22 in an external surface of the housing 2. These pin insertion holes 25 penetrate through the connection hole 22.

An annular groove 3 and an O-ring fitting groove 41 that extend along a circumferential direction of an outer peripheral surface of the joint 1 are disposed side by side in parallel on a front part of the joint 1 configured to be inserted into the housing 2. The O-ring 4 is fitted into the O-ring fitting groove 41. The O-ring 4 is disposed ahead of the annular groove 3 and seals the valve and the joint 1. A tube connection port 11 is disposed on a rear end surface of the joint 1.

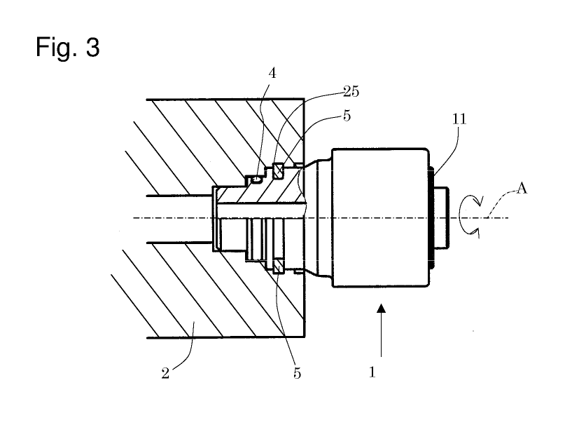

When connecting the joint 1 to the housing 2, with the joint 1 inserted into the housing 2, a U-shaped pin 5 is inserted into the pin insertion holes 25 disposed on the external surface of the housing 2. The pin 5 passes through the annular groove 3 disposed in the joint 2 and comes into engagement with the joint 1. This prevents the joint 1 from slipping out of the housing 2. A connection state is shown in FIG. 3.

On this occasion, the joint 1 is rotatable around a central axis A while being surely sealed by the O-ring 4. Additionally, the joint 1 is prevented from slipping out of the housing 2 by the pin 5, and is also free from risk of loosening due to vibration as in conventional screwing.

Similarly to the joint 1 and the valve 2, the pin 5 may be made of a resin besides metal. The pin 5 may be an engaging member having, for example, a plate-shaped configuration, besides the bar-shaped one as shown in FIG. 1, as long as is engageable with the joint 1 and is configured to hold the joint 1 so as not disengage from the valve 2.

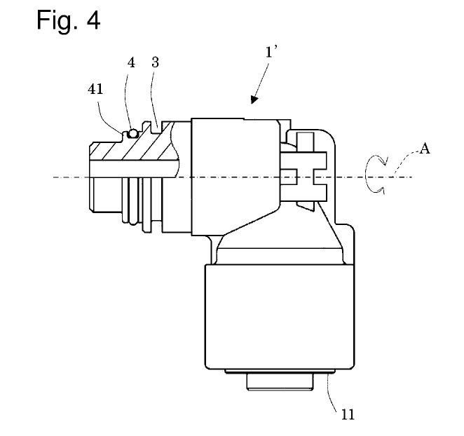

FIG. 4 shows an elbow-shaped joint 1′. Also when connecting the joint 1′, an annular groove 3 and an O-ring fitting groove 41 that are similar to those described above are disposed at an inserting portion into the housing 2. The O-ring 4 is fitted into the O-ring fitting groove 41. Therefore, after insertion into the housing 2, the pin 5 is passed through the annular groove 3 and comes into engagement with the joint 1′ in the same manner as described above. The joint 1′ is also rotatable around the central axis A, and hence the direction of the tube connection port 11 can be changed in any direction.

The joint 1′ is the same as the joint 1 except for having the elbow shape.

### Second Embodiment

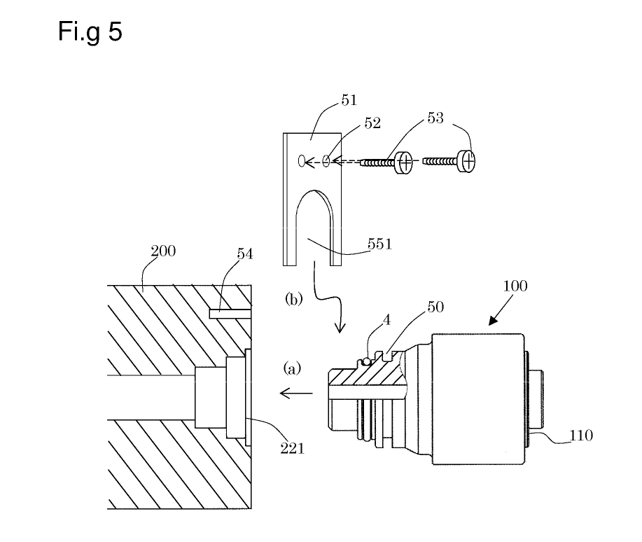

FIG. 5 shows a second embodiment of the present invention. The present embodiment employs a plate member 51 instead of the pin 5 in order to prevent a joint 100 from disengaging from a housing 200 of a valve. The housing 200 is provided with a connection hole 221 configured to accept insertion and connection of the joint 100.

An O-ring 4 is attached to an outer peripheral surface of a portion of the housing 100 which is configured to be inserted into the housing 200, and a connection state ensures sealing performance between the joint 100 and the housing 200 of the valve. Behind an attachment portion for the O-ring 4, an annular groove 50 configured to engage with the plate member 51 is formed along a circumferential direction of the outer peripheral surface. A tube connection port 110 is disposed on a rear part of the joint 100.

The plate member 51 has a U-shaped notch part 551 in a lower part thereof, and has screw insertion holes 52 in an upper part thereof. A material of the plate member 51 may be either the above resin or metal.

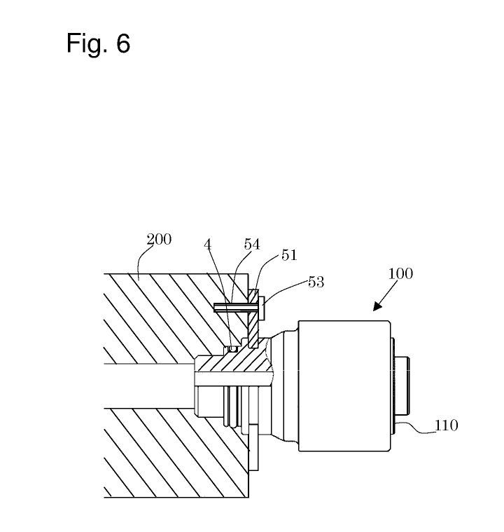

When connecting the joint 100 to the housing 200, a first step is to insert the joint 100 into the housing 200 (along an arrow mark (a) in FIG. 5). In this insertion state, as shown in FIG. 6, the engaging groove 551 of the plate member 51 is located outside the housing 200. In this state, a circumferential edge part of the notch part 551 is engaged with the annular groove 50 by moving down the plate member 51 being brought into contact with a wall surface of the housing 200 (along an arrow mark (b) in FIG. 5). A final step is to respectively insert screws 53 into the screw insertion holes 52 and then screw the screws 53 into screw holes 54 formed in the wall surface of the housing 200, thereby completing the connection of the joint 100 into the valve.

Thus, the joint 100 is engaged with the plate member 51 fixed to the wall surface of the housing 200, thereby surely preventing disengagement from the housing 200.

As described above, the connection mechanisms of the present invention are capable of simply connecting the joint and the valve without using the screwing structure for the joint as in the conventional manner. The connection mechanisms have excellent sealing performance while being free from the risk of loosening due to vibration. Furthermore, lightweighting and cost saving are achievable by using the resin as the material of the joint and/or the housing of the valve.

### INDUSTRIAL APPLICABILITY

There is no likelihood that loosening can occur in the connection between the valve and the joint due to vibration or the like, and airtightness is retainable over a long term. Hence, the connection mechanisms between the valve and the joint according to the present invention are suitably applicable to the connection between the valve and the joint in the air piping, such as air valves, air tanks, air actuators for use in trucks and other various kinds of machines. Particularly, it is possible to contribute to the lightweighting and cost saving of the trucks or the like by using a resin instead of a metal for one or both of the housing of the valve and the joint.

### DESCRIPTION OF THE REFERENCE NUMERAL

1, 1′, 100 joint

2, 200 housing

3, 50 annular groove

4 O-ring

5 pin (engaging member)

11 tube connection port

22 connection hole

25 pin insertion hole (engaging member insertion hole)

41 O-ring fitting groove

51 plate member

220 screw hole

1. A connection mechanism between a valve and a joint configured to connect a tube through the joint to a housing of the valve in the air piping,
wherein at least one of the housing of the valve and the joint is made of a resin,
wherein the housing of the valve comprises a connection hole configured to accept insertion and connection of the joint, and an engaging member insertion hole which is drilled from an external surface of the housing in a direction orthogonal to an axial direction of the connection hole, and penetrates through the connection hole, and
wherein the joint comprises an annular groove formed along a circumferential direction of an outer peripheral surface of the joint, and in an insertion state of the joint into the housing, an engaging member being inserted from the engaging member insertion hole on the external surface of the housing is configured to pass through the annular groove disposed on the joint and come into engagement with the joint.

2. The connection mechanism according to claim 1, wherein the joint has an elbow shape.

3. The connection mechanism according to claim 1, wherein the engaging member is a pin.

4. The connection mechanism according to claims 1 wherein the joint comprises an O-ring fitting groove disposed side by side with the annular groove, and an O-ring is being fitted into the O-ring fitting groove.

5. A connection mechanism between a valve and a joint configured to connect a tube through the joint to a housing of the valve in the air piping,
wherein at least one of the housing of the valve and the joint is made of a resin,
wherein the housing of the valve comprises a connection hole configured to accept insertion and connection of the joint, and
wherein in an insertion state of the joint into the housing, a plate member for preventing disengagement of the joint is configured to be attached to a front surface of the housing and engaged with the joint.
